(19) United States
(12) Patent Application Publication
(10) Pub. No.: US 2018/0269645 A1
(43) Pub. Date: Sep. 20, 2018

(54) HIGH ENERGY FIBER LASER AMPLIFIER WITH REDUCED OPTICAL LINEWIDTH

(71) Applicant: The Johns Hopkins University, Baltimore, MD (US)

(72) Inventors: Brice M. Cannon, Beltsville, MD (US); David M. Brown, Ellicott City, MD (US); Mark J. Mayr, Ellicott City, MD (US); Michael L. Dennis, Ellicott City, MD (US); William E. Torruellas, Ellicott City, MD (US); Jeffrey O. White, Silver Spring, MD (US)

(21) Appl. No.: 15/375,283

(22) Filed: Dec. 12, 2016

Related U.S. Application Data
(60) Provisional application No. 62/301,000, filed on Feb. 29, 2016.

(51) Int. Cl. H01S 3/10; H01S 3/094; H01S 3/11; H01S 3/067; H01S 3/0941; H01S 3/091; H01S 3/23

(52) U.S. Cl. CPC H01S 3/10053; H01S 3/094003; H01S 3/11; H01S 3/10061; H01S 2301/03; H01S 3/0941; H01S 3/0912; H01S 3/10084; H01S 3/2308; H01S 3/06754

(57) ABSTRACT

Example apparatuses and methods are provided that improve laser performance or decrease the frequency or severity of the occurrence of Stimulated Brillouin scattering. One example is a laser device that may include a seed laser configured to generate an optical output, a pattern generator configured to generate a modulation pattern, and a phase modulator configured to apply a modulation scheme to the optical output based on the modulation pattern. The modulation pattern may include a digital sequence and the modulation pattern may be applied to modulate a phase or an amplitude of the optical output.

### CROSS-REFERENCE TO RELATED APPLICATIONS

This application claims priority to and the benefit of co-pending U.S. Provisional Application Ser. No. 62/301,000, filed on Feb. 29, 2016, the entire contents of which are hereby incorporated herein by reference.

### STATEMENT OF GOVERNMENTAL INTEREST

This invention was made with Government support under contract number FA9451-15-D-0025 awarded by the United States Air Force. The Government has certain rights in the invention.

### TECHNICAL FIELD

Example embodiments generally relate to laser devices and, more particularly, relate to high energy fiber lasers.

### BACKGROUND

Providing a high energy fiber laser with a narrow linewidth can be a difficult task. Stimulated Brillouin scattering (SBS) is a phenomenon that can be particularly troublesome in relation to achieving such a laser. SBS occurs when light in a medium encounters optical density variations that may alter its energy and path. The optical density variations may be time dependent variations that are caused by acoustic modes, magnetic modes, or temperature gradients. SBS that occurs, for example within high power amplification stages, may create attenuation, power saturation or backward propagation of light in a fiber amplifier.

Some techniques have been employed to attempt to reduce SBS for high energy laser applications. For example, techniques including varying the refractive index as a function of fiber radius or modulating the phase of the pump light with an radio frequency (RF) noise source of several GHz have both been employed to reduce the optical overlap with the SBS gain spectrum. Other techniques include coiling the fiber or stressing the fiber in some way. However, some of these techniques may not be desirable or optimal in some cases.

### BRIEF SUMMARY OF SOME EXAMPLES

Accordingly, some example embodiments may enable the provision of high energy fiber laser that employs a modulation scheme that may improve laser performance or decrease the frequency or severity of the occurrence of SBS.

According to some example embodiments, a laser device is provided. The laser device may comprise a seed laser configured to generate an optical output, a pattern generator configured to generate a modulation pattern, and a phase modulator configured to apply a modulation scheme to the optical output based on the modulation pattern. The modulation pattern may include a digital sequence and the modulation pattern may be applied to modulate a phase or an amplitude of the optical output.

According to some example embodiments, a phase modulator for a laser device is provided. The phase modulator may comprise an input device in operable communication with an optical output of a seed laser, and a modulator. The modulator may be configured to receive a modulation pattern from a pattern generator in operable communication with the phase modulator, and apply a modulation scheme to the optical output based on the modulation pattern. The modulation pattern may include a digital sequence. Further, applying the modulation scheme may include modulating a phase or an amplitude of the optical output.

According to some example embodiments, a method is provided. The method may comprise receiving, by phase modulator circuitry, an optical output via an operable communication with a seed laser; receiving, by the phase modulator circuitry, a modulation pattern via an operable communication with pattern generator; and applying, by the phase modulator circuitry, a modulation scheme to the optical output based on the modulation pattern. The modulation pattern may include a digital sequence and the modulation pattern may be applied to modulate a phase or an amplitude of the optical output.

### BRIEF DESCRIPTION OF THE SEVERAL VIEWS OF THE DRAWING(S)

Having thus described example embodiments of the invention in general terms, reference will now be made to the accompanying drawings, which are not necessarily drawn to scale, and wherein:

FIG. 1 is a block diagram of a system of components comprising a laser device according to an example embodiment;

FIG. 2 illustrates a graph of power versus spectrogram peak for select digital sequences according to an example embodiment relative to conventional sequences;

FIG. 3 shows a phase and amplitude modulated optical output according to an example embodiment;

FIG. 4 shows an apparatus comprising a phase modulator according to an example embodiment;

FIG. 5 illustrates a block diagram of one instance of the laser controller according to an example embodiment; and

FIG. 6 illustrates a flow chart of a method for controlling a laser according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Some example embodiments may improve the ability of designers to provide a high energy fiber laser (HEFL) to achieve kW-class power levels with reduced optical linewidth through decreased susceptibility to performance degradation by SBS. The techniques described herein may be useful for any application for high energy lasers, including weapons or industrial uses.

In this regard, for example, to suppress SBS, some example embodiments may employ custom, optimized digital sequences in the form of a modulation pattern that, in some example embodiments, are applied to an optical output of a seed laser to analog modulate both the phase and the amplitude of the optical output. Further, polarization multiplexing techniques can be implemented with the modulation scheme to further suppress SBS. The optimization of the modulation scheme may be aimed at providing a maximum output power for a corresponding minimized bandwidth. Accordingly, for example, a modulation scheme that is narrow enough to provide for easy combination may be employed, while the modulation scheme is at the same time of a sufficiently large bandwidth to enable better overall output power.

Typical high power fiber lasers may either use GHz-class RF noise sources to drive a phase modulator, or use a broadband laser diode to ensure the power contained in the SBS gain bandwidth is minimized. Some example embodiments may employ a modulation scheme to achieve relatively higher powers than would otherwise be obtainable using conventional modulation techniques. For example, beam encoding may be useful for current and future high energy fiber laser systems used for applications that require beam combination. Thus, some example embodiments may improve laser performance or decrease the frequency or severity of the occurrence of SBS.

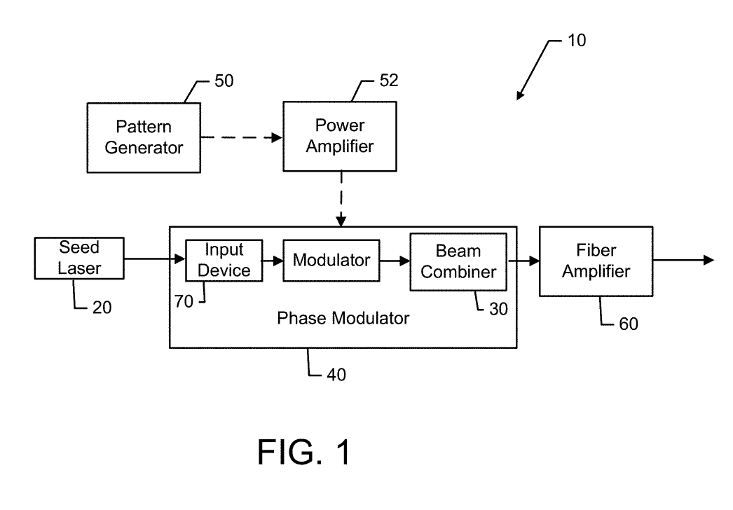

FIG. 1 is a block diagram of a system of components comprising a laser device 10 according to an example embodiment. In FIG. 1, solid connection lines represent operable coupling in the form of an optical connection (e.g., optical fiber), and dashed lines represent electrical connection (e.g., via electrical transmission cables of any suitable type). These representations are merely examples, and one of skill in the art would appreciate that different connection configurations (e.g., optical and electrical with various other in-line hardware) may be implemented to achieve the same or similar results.

The laser device 10 of this example embodiment includes a seed laser 20 that may be optically coupled to a phase modulator 40 and provide an optical output to the phase modulator 40 in the form of light. The phase modulator 40 may be configured to modulate the optical output received, directly or indirectly, from the seed laser 20 based on a modulation scheme. In this regard, for example, a pattern generator 50 may be employed to generate a modulation pattern that is used by the phase modulator 40 to modulate the optical output using the modulation pattern. The modulation pattern provided by the pattern generator 50 may be amplified using a power amplifier 52, prior to feeding the modulation pattern to the phase modulator 40. An output of the phase modulator 40, which may be a modulated output based on the modulation pattern and the optical output of the seed laser 20, may be provided to a fiber amplifier 60. According to some example embodiments, the laser device 10 may also include a polarizer that may receive the optical output of the seed laser 20 and provide a polarizer optical output to the phase modulator 40.

In an example embodiment, the seed laser 20 may be a 1064 nm, 30 MHz linewidth seed diode, or thereabouts. However, numerous other seed lasers may be employed in other embodiments. Thus, for example, the seed laser 20 may include a plurality of diodes powered by a computer controlled power supply. One or more splice trays may also be employed to splice a plurality of fiber optic cables to generate an output of the seed laser 20. The seed laser 20 may therefore be a single frequency seed source to provide an optical output to the phase modulator 40.

In some embodiments, the fiber amplifier 60 may generate a power level of at least about 1 kW. However, other amplifiers may be employed in alternative embodiments. For a 1 kW fiber amplifier, practical application has demonstrated optimal, or at least nearly optimal performance using a bit pattern of 2⁷ such as an international telecommunications union (ITU) standardized bit pattern at a rate of 1 Gbps. In other words, a pattern that is 127 bits with no more than seven consecutive zeros or ones may provide good performance for the laser device 10 at a 1 kW power output. In general, an optimal ITU pattern will increase by 2^{(N+1)} for each doubling of the data rate. Accordingly, an optimal condition may be achieved with a pattern that is short enough to maximize the phase mismatch along the active fiber, but is not so short that when the pattern repeats, backward propagation is again in phase with forward propagation. For longer patterns (e.g., bit pattern of 2³¹, which would include a string of 31 zeros or ones), extensive buildup of SBS may occur for an instance of time (or once per repetition of pattern). For other amplifier sizes, corresponding adjustments to the optimal bit pattern length may be experienced. However, example embodiments using an ITU bit pattern of 2⁷ and a 1 kW fiber amplifier have demonstrated relatively good performance, and may also be optimal for HEL modulation in multi-kW class systems to encode each beam for ease of non-target-in-the-loop incoherent beam applications.

In this regard, with respect to the operation of the pattern generator 50, the pattern generator 50 may be configured to generate a modulation pattern as described herein and be, for example, a 0.5 to 10 Gbits modulation pattern generator. However, other pattern generators may be employed in other example embodiments. The pattern generator 50 may include one or more amplifiers or filters to provide adequate modulation bandwidth and modulation depth when driving the phase modulator 40. The modulation pattern generated by the pattern generator 50 may have a mean value of 0.5 and, in some cases, may have a maximum length of repeating a “0” or “1” that is governed by the sequence length (e.g., a bit pattern of 2⁷ would be a relatively short pattern with a string of seven zeros or ones, while a bit pattern of 2³¹ would be a longer string including thirty-one zeros or ones).

As mentioned above and otherwise herein, the phase modulator 40 may be an optical modulator configured to control the optical phase, amplitude, and polarization of the optical output in the form of light (e.g., a laser beam) received from the seed laser 20 based on, at least partially, the modulation pattern provided by the pattern generator 50. As such, the phase modulator 40 may include an input device 70 configured to receive the optical output of the seed laser 20 and a modulator 72 configured to modulate the optical output of the seed laser 20 based on the modulation pattern. The phase modulator 40 may be an electro-optic modulator, a liquid crystal modulator, or any other suitable type of optical modulator. Furthermore, the phase modulator 40 may be a resonant or wideband type device with modulation bandwidth or optical bandwidth characteristics selected appropriately for the desirable performance characteristics of the laser device 10. An output of the phase modulator 40 may be amplified by the fiber amplifier 60.

More specifically, with respect to the operation and features of the pattern generator 50 and the phase modulator 40 in combination, various optimization techniques may be implemented alone or in combination, according to some example embodiments. In other words, optimization of the power to bandwidth ratio for a laser device such as laser device 10 may be achieved using various techniques that may be employed unilaterally or together and implemented by the pattern generator 50 and the phase modulator 40. In this regard, the pattern generator 50 may configured to provide custom digital sequences in the form of a modulation pattern to be used by phase modulator 40 to modulate the optical output of the seed laser 20. Further, application of the modulation pattern, provided by the pattern generator 50, may operate to modulate both the phase and the amplitude of the optical output of the seed laser 20 using, in some example embodiments, an analog modulation technique. Finally, as further described below with respect to the operation of the phase modulator 40, a polarization multiplexing technique may be implemented.

According to some example embodiments, the modulation pattern provided by the pattern generator 50 to the phase modulator 40 may be one or a combination of custom-designed time-dependent digital or analog modulation patterns that can be used to modulate the phase, amplitude, or polarization of the optical output of the seed laser 20 for amplification and for, for example, a given laser architecture. In this manner, the example approach can differ from past radio frequency noise and pseudo-random bit sequence (PRBS) phase-only modulation techniques. As such, the modulation patterns described herein, can support beam encoding, which can be advantageous for current and future high energy fiber laser systems used for applications that require beam combination.

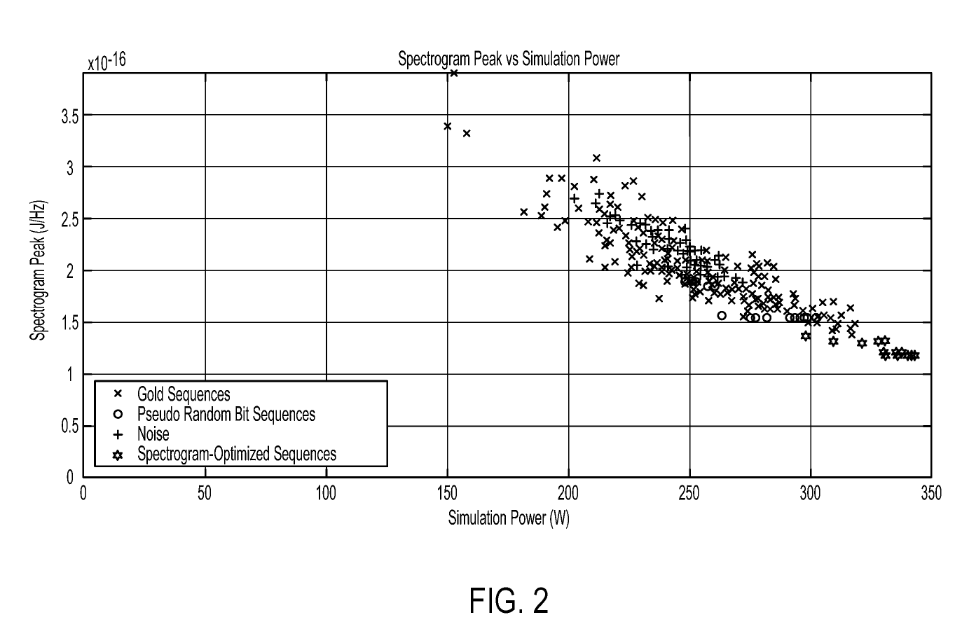

In this regard, the pattern generator 50 may supply modulation patterns that include a digital sequence that may be customized for a given hardware laser design. In this regard, to design optimized sequences, a spectrogram analysis technique may be utilized that facilitates the examination of a time-based behavior of a given modulation pattern over a time period that is the duration of an SBS lifetime. The spectrogram analysis technique may enable rapid (e.g., less than 1 millisecond) identification of arbitrary digital patterns that have stable lineshapes, that also exhibit an absence or minimization of strong frequency components, which can initiate the SBS. The spectrogram analysis technique may utilize a simulated annealing algorithm to minimize the spectrogram peak figure-of-merit. As a result, custom digital sequences may be utilized in a modulation pattern that show approximately a 15% improvement over other conventional sequences, such as, UTI standardized PRBS patterns. To determine the performance of a developed sequence, a full physics HEL SBS numerical simulation code in a Monte-Carlo fashion may be implemented to track the maximum SBS power for a given sequence. In this regard, FIG. 2 shows a plot of the max SBS power as a function of total output power for many commercial telecom and other conventional sequences. The modulation patterns including customer digital sequences (identified as Spectrogram-Optimized Sequences in FIG. 2) are shown as generating a relatively high power at a low spectrogram peak. The improvement of approximately 15% was also experimentally verified via a standard Nufern 1 kilowatts (kW) high energy laser (HEL) system.

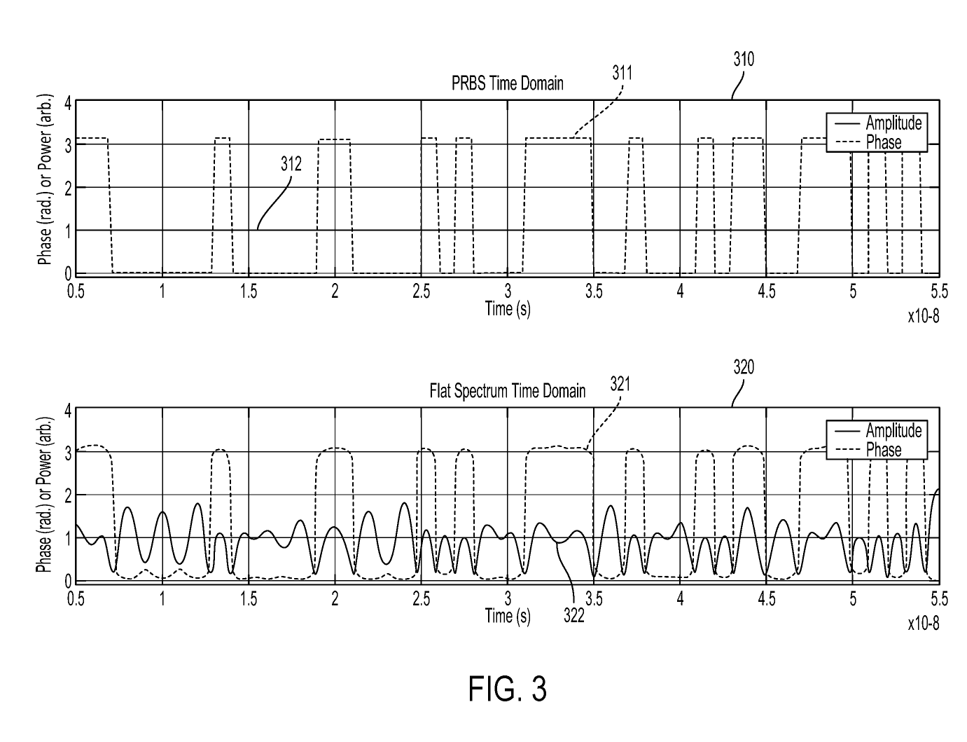

In addition to, or in the alternative to, providing custom digital sequences within a modulation pattern as described above, the pattern generator 50 may apply the digital sequences to modulate both a phase and an amplitude of the optical output of the seed laser 20 based on the modulation pattern provided by the pattern generator 50 to the phase modulator 40. An example of an implementation of such a pattern is shown at 320 of FIG. 3 as a Flat Spectrum Time Domain Plot in comparison with a PRBS Time Domain Plot 310. The signal 320 is shown as a phase plot 321 and an amplitude plot 322 after both phase and amplitude modulation have been implemented, which can be compared, respectively, to the PRBS Time Domain Plot 310 having a phase plot 311 and an amplitude plot 312. As can be seen, the phase plot 321 and the amplitude plot 322 are shown as being analog modulated to reduce high frequency contributions and resulting in relatively smoother transitions (e.g., more rounded), which reduces the contribution to SBS. In this regard, the tones of the modulation pattern need not, or may not, be fixed in frequency, but may remain balanced to maintain a square optical spectrum. In this regard, use of a modulation pattern to be applied to modulate both the phase and the amplitude of the optical output of the seed laser 20 has led to, according to some example embodiments, an approximate 20% improvement over conventional techniques.

Additionally or alternatively, yet another technique for suppressing SBS may be to apply polarization multiplexing to the optical output of the seed laser 20 via the beam combiner 30. Polarization multiplexing may include combining orthogonally polarized signals from a single seed laser. In this regard, the phase modulator 40 may be configured to combine signals extracted from the optical output of the seed laser 20 via the beam combiner 30, which may be a polarization beam combiner. The signals extracted from the optical output may be phase modulated via the modulation pattern such that the signals are orthogonally polarized.

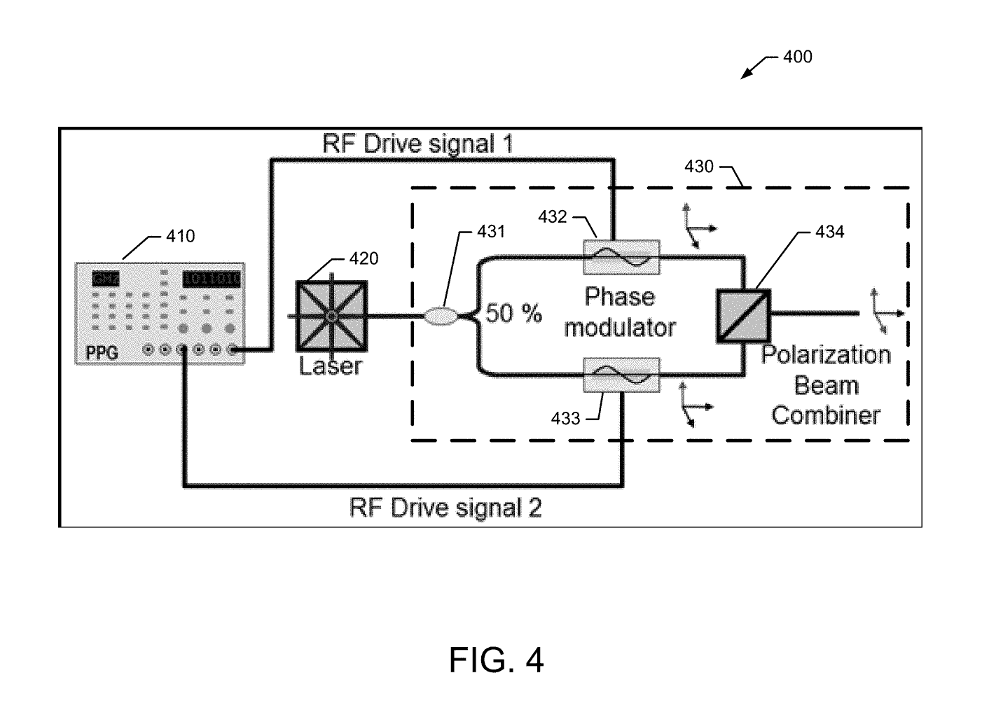

In this regard, FIG. 4 illustrates an example apparatus including a phase modulator configured to perform polarization multiplexing according to various example embodiments. The laser device 400 may include a pattern generator 410, a seed laser 420, and a phase modulator 430. The seed laser 420 may be the same or similar to the seed laser 20 described above. Further, the pattern generator 410 may be the same or similar to the pattern generator 50. However, the modulation pattern relating to polarization multiplexing may be provided to phase modulator 430 via two radio frequency drive signals (i.e., RF Drive signal 1 and RF Drive signal 2). The seed laser 420 may provide an optical output to the signal splitter 431, and the split signals may be provided to modulators 432 and 433, respectively. The RF Drive signal 1 may be modulated with the signal at modulator 432 to generate a first signal, and RF Drive signal 2 may be modulated with the signal at modulator 433 to generate a second signal. The first signal and the second signal may have a relative orthogonal polarization and the signals may be combined by the polarization beam combiner 434, which may operate in the same or similar manner as the beam combiner 30, to generate a polarization multiplexed output signal, which may be provided to a fiber amplifier (not pictured). According to various example embodiments, the signals combined at the polarization beam combiner 434 may be linearly polarized and phase modulated.

Testing to apply polarization multiplexing, as described above, has indicated that an approximate 20% improvement in output power from a coiled weakly birefrigent fiber using a given modulation pattern can be realized when the pattern was polarization multiplexed. The percentage improvement using this polarization multiplexed technique may be proportional to the magnitude of fiber birefringence. In the case of polarization-maintaining fiber (e.g., highly birefringent fiber) an additional factor of at least two can be expected by utilizing polarization multiplexing.

As mentioned above, the SBS suppression techniques described herein can be used in isolation or combined to achieve improved results. In this regard, if the techniques are combined some testing has indicated that an improvement factor of the power to linewidth ratio may be 1.5 to 2 over conventional techniques that employ none of the techniques described herein.

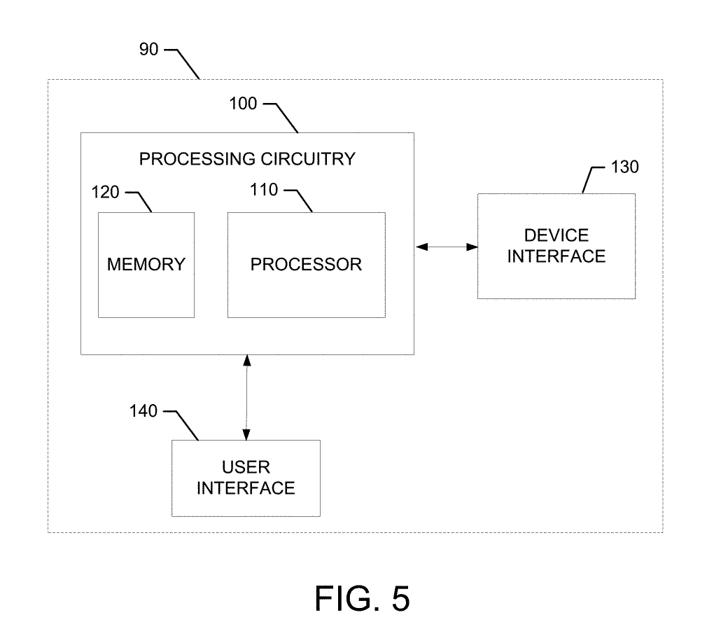

In some embodiments, the laser device 10 (or at least some components thereof) may operate under computer control, or at least under the control of some form of control element (e.g., laser controller 90) that may provide control signals for operation of the pattern generator 50, the phase modulator 40, or the seed laser 20. In an example embodiment, the laser controller 90 may be a computer controlled device, and in some embodiments may be programmable to define modulation patterns that may be desirable for implementation in modulation schemes. FIG. 5 illustrates a block diagram of one instance of the laser controller 90 according to an example embodiment.

As shown in FIG. 5, the laser controller 90 may include or otherwise be in communication with processing circuitry 100 that is configurable to perform actions in accordance with example embodiments described herein. As such, for example, the functions attributable to the laser controller 90 may be carried out by the processing circuitry 100.

The processing circuitry 100 may be configured to perform data processing, control function execution or other processing and management services according to an example embodiment of the present invention. In some embodiments, the processing circuitry 100 may be embodied as a chip or chip set. In other words, the processing circuitry 100 may comprise one or more physical packages (e.g., chips) including materials, components or wires on a structural assembly (e.g., a baseboard). The processing circuitry 100 may be configured to control a phase modulator (e.g., phase modulator 40) and the phase modulation scheme employed by the laser device. Further, the processing circuitry 100 may be configured to control a single frequency seed source employed by a seed laser (e.g., seed laser 20).

In an example embodiment, the processing circuitry 100 may include one or more instances of a processor 110 and memory 120 that may be in communication with or otherwise control a device interface 130 and, in some cases, a user interface 140. As such, the processing circuitry 100 may be embodied as a circuit chip (e.g., an integrated circuit chip) configured (e.g., with hardware, software or a combination of hardware and software) to perform operations described herein.

The user interface 140 (if implemented) may be in communication with the processing circuitry 100 to receive an indication of a user input at the user interface 140 or to provide an audible, visual, mechanical or other output to the user. As such, the user interface 140 may include, for example, a display, one or more buttons or keys (e.g., function buttons), or other input/output mechanisms (e.g., keyboard, microphone, speakers, cursor, joystick, lights or the like).

The device interface 130 may include one or more interface mechanisms for enabling communication with other devices. In some cases, the device interface 130 may be any means such as a device or circuitry embodied in either hardware, or a combination of hardware and software that is configured to receive or transmit data from/to devices in communication with the processing circuitry 100.

In an exemplary embodiment, the memory 120 may include one or more non-transitory memory devices such as, for example, volatile or non-volatile memory that may be either fixed or removable. The memory 120 may be configured to store information, data, applications, instructions or the like for enabling the laser controller 90 to carry out various functions in accordance with exemplary embodiments of the present invention. For example, the memory 120 could be configured to buffer input data for processing by the processor 110. Additionally or alternatively, the memory 120 could be configured to store instructions for execution by the processor 110. As yet another alternative, the memory 120 may include one or more databases that may store a variety of data sets indicative of patterns or encoding schemes to be employed. Among the contents of the memory 120, applications may be stored for execution by the processor 110 in order to carry out the functionality associated with each respective application. In some cases, the applications may include directions for control of the laser device 10 or the components thereof to achieve desirable modulation patterns or modulation schemes that are desired for various laser device 10 operations.

The processor 110 may be embodied in a number of different ways. For example, the processor 110 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 110 may be configured to execute instructions stored in the memory 120 or otherwise accessible to the processor 110. As such, whether configured by hardware or by a combination of hardware and software, the processor 110 may represent an entity (e.g., physically embodied in circuitry—in the form of processing circuitry 100) capable of performing operations according to embodiments of the present invention while configured accordingly. Thus, for example, when the processor 110 is embodied as an ASIC, FPGA or the like, the processor 110 may be specifically configured hardware for conducting the operations described herein. Alternatively, as another example, when the processor 110 is embodied as an executor of software instructions, the instructions may specifically configure the processor 110 to perform the operations described herein.

In an example embodiment, the processor 110 (or the processing circuitry 100) may be embodied as, include or otherwise control the laser controller 90. As such, in some embodiments, the processor 110 (or the processing circuitry 100) may be said to cause each of the operations described in connection with the laser controller 90 by directing the laser controller 90 to undertake the corresponding functionalities responsive to execution of instructions or algorithms configuring the processor 110 (or processing circuitry 100) accordingly. For example, the processor 110 may define programmable operating frequencies or modulation patterns for modulation of the output of the laser device 10 to produce a high power, fiber laser having desirable characteristics responsive to execution of instructions stored in the memory 120.

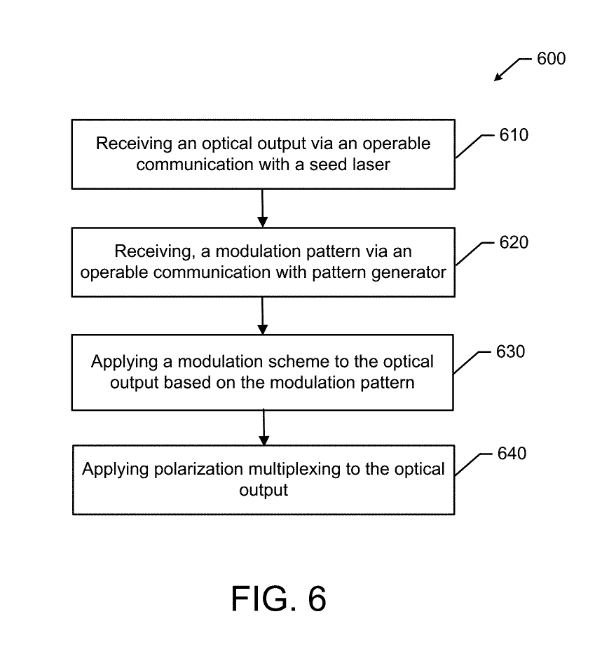

Accordingly, some example embodiments, the laser controller 90 implementing a phase modulator via processing circuitry 100 (as phase modulator circuitry), may be configured to perform the following functionalities to implement an example method 600 as provided in FIG. 6. The phase modulator circuitry may be configured to receive an optical output via an operable communication with a seed laser at 610, receive a modulation pattern via an operable communication with pattern generator at 620, and apply a modulation scheme to the optical output based on the modulation pattern at 630. The modulation pattern may include a digital sequence and the modulation pattern may be applied to modulate either or both of a phase and an amplitude of the optical output. At 640, the phase modulator circuitry may be configured to apply polarization multiplexing to the optical output. Applying polarization multiplexing may include applying polarization multiplexing by orthogonally polarizing signals extracted from the optical output prior to combining. Further, according to some example embodiments, the modulation pattern may be applied to analog modulate both the phase and the amplitude of the optical output.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A laser device comprising:
a seed laser configured to generate an optical output;
a pattern generator configured to generate a modulation pattern; and
a phase modulator configured to apply a modulation scheme to the optical output based on the modulation pattern,
wherein the modulation pattern includes a digital sequence and wherein the modulation pattern is applied to modulate a phase or an amplitude of the optical output.

2. The laser device of claim 1, wherein the phase modulator is further configured to apply polarization multiplexing to the optical output.

3. The laser device of claim 2, wherein the phase modulator includes a polarization beam combiner and wherein being configured to apply polarization multiplexing includes being configured to combine signals extracted from the optical output via the polarization beam combiner.

4. The laser device of claim 3, wherein the phase modulator is configured to apply polarization multiplexing by combining the signals extracted from the optical output, wherein prior to combining the signals extracted from the optical output, the signals are orthogonally polarized.

5. The laser device of claim 1, wherein the pattern generator is further configured to generate the modulation pattern, the modulation pattern being applied to analog modulate the phase or the amplitude of the optical output.

6. The laser device of claim 1, further comprising a power amplifier configured to amplify the modulation pattern from the pattern generator prior to provision of the modulation pattern to the phase modulator.

7. The laser device of claim 1, further comprising a fiber amplifier configured to amplify an output of the phase modulator to generate a power level of at least about 1 kW.

8. The laser device of claim 1, wherein the seed laser comprises a seed diode having a linewidth of about 30 MHz.

9. The laser device of claim 1, further comprising a laser controller configured to control operation of the laser device.

10. The laser device of claim 9, wherein the laser controller includes processing circuitry configured to control the phase modulator and the modulation scheme employed by the laser device.

11. The laser device of claim 10, wherein the laser controller includes processing circuitry configured to control a single frequency seed source employed by the seed laser.

12. A phase modulator for a laser device, the phase modulator comprising:
an input device in operable communication with an optical output of a seed laser; and
a modulator configured to:
receive a modulation pattern from a pattern generator in operable communication with the phase modulator; and
apply a modulation scheme to the optical output based on the modulation pattern, wherein the modulation pattern includes a digital sequence and wherein applying the modulation scheme includes modulating a phase or an amplitude of the optical output.

13. The phase modulator of claim 12 further configured to apply polarization multiplexing to the optical output.

14. The phase modulator of claim 13, further comprising polarization beam combiner and wherein being configured to apply polarization multiplexing includes being configured to combine signals extracted from the optical output via the polarization beam combiner.

15. The phase modulator of claim 14, wherein being configured to apply polarization multiplexing includes being configured to apply polarization multiplexing by combining the signals extracted from the optical output, wherein prior to combining the signals extracted from the optical output, the signals are orthogonally polarized.

16. The phase modulator of claim 12, wherein being configured to apply the modulation scheme includes being configured to apply the modulation scheme based on the modulation pattern, the modulation pattern being applied to analog modulate both the phase and the amplitude of the optical output.

17. A method comprising:
receiving, by phase modulator circuitry, an optical output via an operable communication with a seed laser;
receiving, by the phase modulator circuitry, a modulation pattern via an operable communication with pattern generator; and
applying, by the phase modulator circuitry, a modulation scheme to the optical output based on the modulation pattern, wherein the modulation pattern includes a digital sequence and wherein the modulation pattern is applied to modulate a phase or an amplitude of the optical output.

18. The method of claim 17 further comprising applying polarization multiplexing to the optical output.

19. The method of claim 18, wherein applying polarization multiplexing includes applying polarization multiplexing by combining signals extracted from the optical output, wherein prior to combining the signals extracted from the optical output, the signals are orthogonally polarized.

20. The method of claim 17, wherein applying the modulation scheme includes applying the modulation scheme based on the modulation pattern, the modulation pattern being applied to analog modulate both the phase and the amplitude of the optical output.
